(19) United States
(12) Patent Application Publication
(10) Pub. No.: US 2007/0233506 A1
(43) Pub. Date: Oct. 4, 2007

(54) Privately Managed Entertainment and Recreation Supplies Provisioning Method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/548,191

(22) Filed: Oct. 10, 2006

Related U.S. Application Data
(63) Continuation-in-part of application No. 11/384,037, filed on Mar. 17, 2006.
(63) Continuation-in-part of application No. 11/394,350, filed on Mar. 30, 2006.
(63) Continuation-in-part of application No. 11/279,333, filed on Apr. 11, 2006.
(63) Continuation-in-part of application No. 11/379,929, filed on Apr. 24, 2006.
(63) Continuation-in-part of application No. 11/381,247, filed on May 2, 2006.
(63) Continuation-in-part of application No. 11/381,257, filed on May 2, 2006.
(63) Continuation-in-part of application No. 11/381,265, filed on May 2, 2006.
(63) Continuation-in-part of application No. 11/381,277, filed on May 2, 2006.
(63) Continuation-in-part of application No. 11/383,022, filed on May 12, 2006.
(63) Continuation-in-part of application No. 11/420,594, filed on May 26, 2006.
(63) Continuation-in-part of application No. 11/421,694, filed on Jun. 1, 2006.
(63) Continuation-in-part of application No. 11/423,594, filed on Jun. 12, 2006.
(63) Continuation-in-part of application No. 11/425,043, filed on Jun. 19, 2006.
(63) Continuation-in-part of application No. 11/426,231, filed on Jun. 23, 2006.
(63) Continuation-in-part of application No. 11/456,472, filed on Jul. 10, 2006.
(63) Continuation-in-part of application No. 11/461,605, filed on Aug. 1, 2006.
(63) Continuation-in-part of application No. 11/461,624, filed on Aug. 1, 2006.
(63) Continuation-in-part of application No. 11/462,795, filed on Aug. 7, 2006.
(63) Continuation-in-part of application No. 11/462,845, filed on Aug. 7, 2006.
(63) Continuation-in-part of application No. 11/464,751, filed on Aug. 15, 2006.
(63) Continuation-in-part of application No. 11/464,764, filed on Aug. 15, 2006.
(63) Continuation-in-part of application No. 11/464,775, filed on Aug. 15, 2006.
(63) Continuation-in-part of application No. 11/464,788, filed on Aug. 15, 2006.
(63) Continuation-in-part of application No. 11/464,799, filed on Aug. 15, 2006.
(63) Continuation-in-part of application No. 11/465,063, filed on Aug. 16, 2006.
(63) Continuation-in-part of application No. 11/466,727, filed on Aug. 23, 2006.
(63) Continuation-in-part of application No. 11/466,953, filed on Aug. 24, 2006.
(63) Continuation-in-part of application No. 11/470,156, filed on Sep. 5, 2006.
(63) Continuation-in-part of application No. 11/531,651, filed on Sep. 13, 2006.
(63) Continuation-in-part of application No. 11/532,461, filed on Sep. 15, 2006.
(63) Continuation-in-part of application No. 11/535,021, filed on Sep. 25, 2006.
(63) Continuation-in-part of application No. 11/535,282, filed on Sep. 26, 2006.
(63) Continuation-in-part of application No. 11/537,469, filed on Sep. 29, 2006.
(63) Continuation-in-part of application No. 11/539,798, filed on Oct. 9, 2006.
(63) Continuation-in-part of application No. 11/539,861, filed on Oct. 9, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.

(51) Int. Cl. G06Q 10/00; G06Q 30/00

(52) U.S. Cl. 705/1

(57) ABSTRACT

A private civil security subscription mechanism serves to facilitate the provision of survival supplies for corresponding authorized beneficiaries. These privately managed survival supplies include post-catastrophe supplies directed to entertainment and recreational purposes. The inclusion of such entertainment and recreational supplies can assist authorized beneficiaries to thrive following a civilly-catastrophic event. The post-catastrophe supplies may be provided based on the authorized beneficiary's needs, requirements, and/or preferences. The supplies may be organized into a unit of supplies to facilitate delivery of the supplies to an authorized beneficiary.

### RELATED APPLICATIONS

This application claims the benefit of the filing date of U.S. provisional application Nos. 60/820,628, 60/823,806, 60/825,524, 60/825,976, 60/826,491, 60/827,591, 60/827,828, 60/828,341 and 60/828,342 which are hereby incorporated in their entirety herein.

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

Privately Provisioned Survival Supplies Delivery Method as filed on Aug. 15, 2006 and having application Ser. No. 11/464,751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY as filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB-UNIT-BASED SURVIVAL SUPPLIES PROVISIONING METHOD as filed on Sep. 25, 2006 and having application Ser. No. 11/535,021;

RESOURCE CONTAINER AND POSITIONING METHOD AND APPARATUS as filed on Sep. 26, 2006 and having application Ser. No. 11/535,282;

PUBLICLY-FUNDED PRIVATELY FACILITATED ACCESS TO SURVIVAL RESOURCES METHOD as filed on Sep. 29, 2006 and having application Ser. No. 11/537,469;

ELECTRICITY PROVIDING PRIVATELY PROVISIONED SUBSCRIPTION-BASED SURVIVAL SUPPLY UNIT METHOD AND APPARATUS as filed on Oct. 9, 2006 and having application Ser. No. 11/539,798;

PREMIUM-BASED CIVILLY-CATASTROPHIC EVENT THREAT ASSESSMENT as filed on Oct. 9, 2006 and having application Ser. No. 11/539,861; the contents of each of which are fully incorporated herein by this reference.

### TECHNICAL FIELD

This invention relates generally to the provision of post-catastrophe supplies.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related actions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swath of a given civil community. Any number of natural and/or non-naturally-caused events can greatly disrupt society's infrastructure and ability to provide one or more life-sustaining resources such as water, nutrition, shelter, and the like.

This situation exists in large measure due to the just-in-time nature of modern inventory and control schemes and practices. As but one example, studies have shown that a typical modern urban grocery store has but a few days worth of inventory on hand at any given time. Without a virtually constant re-supply stream, shelves would quickly go bare. A significant disruption to supply chains, then, can lead to a rapid depletion of available stock. This, in turn, can lead to critical shortages of necessary emergency supplies at the very moment when such supplies are most needed. The unpredictability with respect to what supplies may become limited in this regard can comprise a particularly troubling component of this problem.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk provisioning (let alone the comfort) of their citizens in the face of many or most catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed to and falsely secure with existing efficient just-in-time delivery systems that provide the illusion of plenty while undercutting the perception of risk.

As a result, many (if not most) individuals and their families are largely bereft of the supplies that they will need should a civilly-catastrophic event befall them. This shortcoming tends to be relatively comprehensive; most people have neither a sufficient selection of survival supplies nor a sufficient quantity. For people who do have a store of supplies set aside against such an eventuality, it can be a considerable burden to maintain and ensure the freshness, vitality, and usability of those supplies. At the same time, the same civilly-catastrophic event that occasions their need for supplies will also likely disrupt relevant supply chains enough to cause a partial or complete shortage of supplies at their local merchants. The unfortunate net result is a relatively near term severe need for a variety of survival supplies that will often go unmet for lengthy periods of time.

As noted, these shortcomings of the prior art tend to be comprehensive. For example, even when some supplies are maintained or accounted for, the focus tends to be exclusively (or almost exclusively) upon baseline survival. In some instances such a bias can be appropriate. In other instances, however, such single-mindedness can perhaps be seen as erring on the side of paucity with respect to various accoutrements of modern life that bring relief from stress, opportunities for social interaction and communion, diversion for young family members, and so forth.

### BRIEF DESCRIPTION OF THE DRAWING

The above needs are at least partially met through provision of the privately managed entertainment and recreation supplies provisioning method described in the following detailed description, particularly when studied in conjunction with the drawing, wherein:

FIG. 1 comprises a flow diagram as configured in accordance with various embodiments of the invention.

Skilled artisans will appreciate that elements in the figure are illustrated for simplicity and clarity. For example, common but well-understood elements that are useful or necessary in a commercially feasible embodiment are often not described in order to facilitate a less obstructed understanding of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a consideration-based private civil security subscription-based approach serves to facilitate the procurement of survival supplies for corresponding authorized beneficiaries and to further facilitate the organization, management, and selection of such supplies. In addition, various approaches are set forth with respect to the selection of the form and manner of providing, storing, and delivering the supplies. These supplies can include entertainment and/or recreation-related or based materials of various kinds and types. By one approach, for example, this can comprise creating a unit of post-catastrophe supplies substantially dedicated to entertainment material.

These supplies will likely also comprise various and sundry consumable and/or non-consumable provisions that are more clearly and specifically related to human survival, such as water, food, protective clothing, and the like. Various examples of such provisions are set forth in detail in various of the above-referenced patent applications and, for the sake of brevity, will not be reiterated here.

So configured, authorized beneficiaries of such consideration-based private civil security subscriptions will have concrete, predictable access to survival supplies, including entertainment material as appropriate or as desired, upon the occurrence (and/or threat) of a civilly-catastrophic event. The selection and quantity of emergency survival items can be generally selected (and their maintenance governed) by experts and hence relieve the authorized beneficiary of responsibility in this regard.

These steps are readily facilitated without dependency upon governmental oversight, participation, or control. The particular supplies (and/or quantity of supplies) provided can vary with the needs and requirements of the authorized beneficiaries. Importantly, via these teachings, an individual can take important steps to bring a considerably improved measure of security and comfort into their lives, knowing that, should a civilly-catastrophic event indeed be visited upon them, they will have an extraordinary and reliable access to survival supplies.

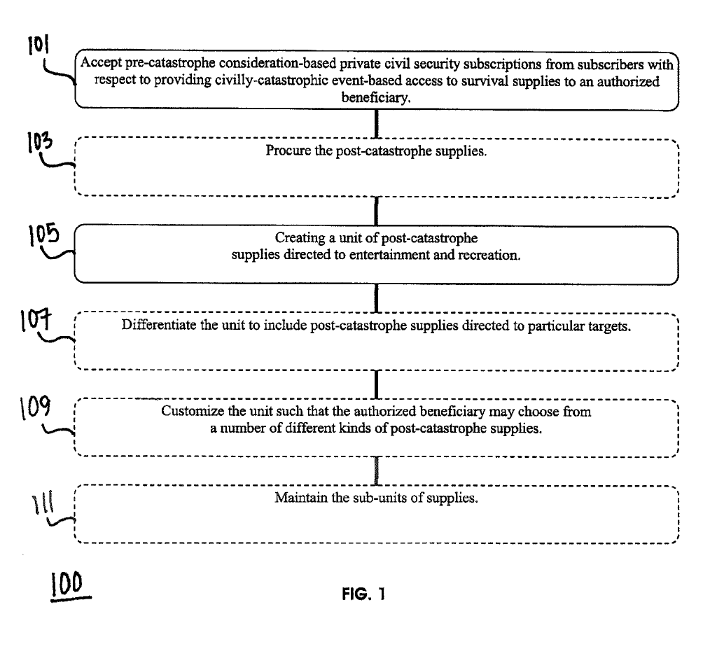

These and other benefits may become clearer upon making a thorough review and study of the following detailed description. Referring now to the drawings, and in particular to FIG. 1, an illustrative process 100 provides for accepting 101 consideration-based private civil security subscriptions from corresponding subscribers with respect to providing civilly-catastrophic event-based access to survival supplies. The provision of such supplies comprises, at least in part, providing post-catastrophe supplies dedicated to entertainment and/or recreation supplies. Such supplies may not only help the authorized beneficiary survive a civilly-catastrophic event, but may help the authorized beneficiary thrive after such an event. This right of access can pertain, if desired, to a predetermined period of time. For example, a given subscription can relate to providing access to the survival supplies for a one-year period of time for one or more authorized beneficiaries as correspond to that subscription.

By one approach, these subscriptions may be accepted by, for example, a for-profit business. By another approach a not-for-profit business (such as a membership-based-entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extend past the death of a named subscription beneficiary and further provides for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a one-time-only right of access or a perpetual right of access that may be retained, transferred, inherited, or the like);

ownership-based rights of access (as may occur when the subscription provides for ownership rights with respect to the survival supplies, when the subscriber comprises a stockholder of an entity that serves, in turn, to control such survival supplies and/or such access, and so forth);

non-transferable rights of access (as may occur when the subscription, by its terms and conditions, prohibits transfer of the right of access to the survival supplies from a first named beneficiary to another);

transferable rights of access (as may occur when the subscription, by its terms and conditions, permits conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided interest by and between multiple subscription beneficiaries with respect to a right to access the survival supplies);

non-ownership based rights of access (as may occur when the subscription, by its terms and conditions, establishes the aforementioned right of access via, for example, a lease, a rental, or borrowing construct);

option-based rights of access (as may occur when the subscription, by its terms and conditions, establishes a right for an authorized beneficiary to later obtain access to such resources upon, for example, paying an additional supplemental amount at that time).

If desired, a plurality of differentiated subscription opportunities can be offered in this regard. This plurality of differentiated subscription opportunities can correspond, for example, to providing access to differing selections and/or quantities of survival supplies. As but one very simple illustration in this regard, such subscription opportunities can differ from one another at least with respect to cost. This, in turn, provides subscriber choice with respect to selecting a particular subscription that best meets their specific needs and/or budget limitation.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access to survival supplies in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice. In addition, or in lieu thereof, such access may be predicated, if desired, upon a requirement of a particular level of objectivity or subjectively ascertained likelihood that a particular category or kind of civilly-catastrophic event will occur within a particular period of time.

As used herein, “civilly-catastrophic event” will be understood to refer to an event that substantially and materially disrupts a society's local, regional, and/or national infrastructure and ability to provide in ordinary course for at least one life-sustaining resource. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation (or worsening) of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, severe weather-related events (such as hurricanes, tsunamis, extreme droughts, widespread or unfortunately-targeted tornadoes, extreme hail or rain, and the like, flooding, and so forth), severe geological events (such as earthquakes, volcanic activity, and so forth), severe astronomical events (such as collisions with comets, large asteroids, and so forth, extreme solar flares, and the like), severe environmental events (such as widespread uncontrolled fire or the like), severe agricultural event (such as a widespread crop failure, contamination, or famine) and global or regional pandemics, to note but a few.

Examples of non-naturally-caused disasters capable of initiating a civilly-catastrophic event include both unintended events as well as intentional acts of aggression such as war, terrorism, madness, or the like. Examples of non-naturally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, exposure to dangerous mutagenic circumstances or influences, and so forth.

This process 100 also provides for acquiring or procuring 103 the corresponding survival supplies for the authorized beneficiaries. Such procurement can be achieved through any of a variety of means. By one approach the items may be acquired on the open market. By another approach the items may be purchased or otherwise acquired from third parties via private negotiations. By yet another approach the entity that provides and accepts these subscriptions may itself create (through manufacturing, farming, or the like) the items of interest. In some cases, the acquired item may comprise a staple of ordinary commerce. In other cases, the acquired item may be unique and/or proprietary to the acquiring/storing entity.

The survival supplies procured 103 include, at least in part, post-catastrophe supplies preferably directed to general entertainment and recreation purposes. In order to thrive, and not merely survive after the occurrence of a civilly-catastrophic event, an authorized beneficiary may prefer to have access to a number of supplies that may not be directed to strictly utilitarian purposes. Both entertainment and recreation supplies may provide diversion, pleasure, and amusement and, at least in that manner, are similar. In addition, some activities, such as playing games, may have utilitarian and education or recreational purposes that may help develop practical skills, serve as a form of exercise, provide educational training, and so forth. In addition to diversion, pleasure, and amusement, entertainment and recreation may also be therapeutic for those who have experienced stressful and traumatic events. Participation in entertaining or recreational activities, events, and performances can refresh individuals who are feeling overwhelmed and may have other positive effects on an individual's general health and welfare.

A civilly-catastrophic event will no doubt be a trying experience for those involved. Excessive and/or prolonged stress has been shown to cause various physical and mental symptoms and may make individuals more susceptible to a number of health problems. Entertainment and recreation may alleviate some of the resulting stress and help those involved take their minds off of their trials and tribulations. Participation in entertainment and/or recreational activities can also help individuals avoid exhaustion or burn out. In addition, the entertainment and recreation supplies can provide a number of other benefits through calming or relaxing sensory experiences. The benefits of such activities may flow to others who are not actually participating in the entertainment or recreation. For example, after a civilly-catastrophic event a group of children may need to be preoccupied while their parents and guardians attend to other tasks, such as furnishing the families' shelter or purifying drinking water. In such a situation, providing the children with entertainment or recreation may not only calm and relax the children, but may also provide parents with a respite from some parental duties so that other tasks can be accomplished.

Depending on the requirements and preferences of an authorized beneficiary, the unit can include any of a number of different supplies. The post-catastrophe supplies dedicated to entertainment and recreation might include, but are not limited to:
media supplies (which may include a media console, a media display, a media player, media content, media accessories, a videogame console, videogames, videogame accessories, an audio player, headphones, speakers, a camera, a video recorder, an electronic game, a personal computer, a hard drive, a media recorder, and so forth);
a game accessory (which may include a board game, playing cards, card game accessories, dice, chips, jacks, string, gambling equipment, gambling accessories, videogame equipment, videogame supplies, a computer, computer accessories, a game controller, a wireless game controller, a headset, a wireless headset, a power inverter, a foosball table, an air hockey table, a table hockey unit, a handheld game, chess supplies, an arcade game, a pinball machine, game instructions, marbles, tic-tack-toe set, pick-up-sticks, shuffleboard equipment and supplies, and so forth);
a children's toy (which may include building sets, models, blocks, play sets, magic tricks, magic accessories, dress-up clothing, a doll, doll accessories, a doll house, doll clothes, a yo-yo, a flying disc, an action figure, action figure accessories, plush toys, stuffed animals, string, playground equipment, a water sprinkler, a musical instrument, a train, train accessories, a bicycle, a vehicle, trucks, cars, die-cast figures, modeling dough, a balloon, a scooter, a tricycle, a wagon, stilts, a squirt gun, a water gun, a pogo-stick, a flying triangle, a flying donut-shaped object, and so forth);
a wheeled vehicle (which may include vehicles having a variety of wheels and a variety of power supplies, and so forth);
a ball (which may be any of a variety of sizes, and materials, and may be filled with a variety of substances, and so forth);
a coin (which may include a variety of sizes and materials for collecting and trading);
sports equipment (which may include a bat, a stick, a racquet, a paddle, a ball, a net, a shuttlecock, a goal structure, a base, a mitt, a glove, goggles, a swim cap, scuba gear, flotation devices, batting practice system, a ball return, a rope, a mallet, a helmet, protective gear, sports shoes, stretching equipment, a yoga mat, a road bike, an off-road bike, sports clothing, exercise equipment, free weights, a pedometer, a punching bag, a jump rope, a canoe, a kayak, a trampoline, ice skates, roller skates, in-line skates, a skateboard, a fishing rod, a fishing reel, fish hooks, fish bait, a fishing net, a crab trap, a knife, a tackle box, fishing tackle, paintball equipment, croquet equipment, a pogo stick, stilts, a bow, arrow shafts, arrow heads, archery accessories, a target, firearms, a handgun, a muzzleloader, a shotgun, a rifle, an air gun, a sporting clay gun, a shooting vest, hull bags, shell bags, clay birds, binoculars, shotgun reloading components, ammunition, a firearm cleaning kit, a scope, scents and decoys, a tree stand, animal call devices, a golf club, a golf bag, golf tees, golf accessories, darts, a dart board, dart accessories, bean bags, horse shoes, stakes, lawn jarts, a pool cue, a billiard table, a ping pong table, bowling pins, scuba gear, a bungee cord, and so forth);
reading material (which may include children's books and children's educational activity books such as a coloring book, a draw-by-number book, a paint-by-number book, a sticker book, a book of nursery rhymes, and so forth, a periodical, a non-periodical, a magazine, a newspaper, a newsweekly, a scientific journal, an artistic journal, an academic journal, a special interest journal, a manual, educational text, reference material, an encyclopedia, a dictionary, a pamphlet, a review, an audio book, a comic book, papers, classical literature, fictional material, non-fictional material, historical material, memoirs, dramatic material, poetry, prose, ballad, classics, epic literature, legendary material, mythical material, folklore, erotica, essay-based material, science fiction material, in a variety of mediums such as a hardback book, a paperback book, digital copies, audio tape such as a cassette tape, microfilm, microfiche, magazine, newspaper, flyer, pamphlet, and so forth);
a musical instrument (which may include wind instruments including both brass and woodwind instruments, percussion instruments, string instruments, electronic instruments, keyboard instruments, lamellaphone instruments, and so forth);
sheet music (which may include pamphlets, books, electronic copies, and so forth);
an amplifier;
a microphone;
a karaoke machine;
a mixing console;
instrument connectivity cables;
a remote control car;
racing equipment;
racing accessories;
a jigsaw puzzle;
a puzzle collection (which may include sudoku puzzles, cross word puzzles, word search puzzles, letter arrangement games, cryptograms, block figure puzzle, and so forth);
spa equipment (which may include a massage table, a foot bath, a manicure station, a stylist chair, towels, hair styling equipment, a tanning bed, a whirlpool, a steam bath, a steam room, a sauna, a mud bath, and so forth);
spa supplies (which may include polish, oil, scrub, files, scissors, wax, wraps, muslin strips, brushes, razors, dye, pillow, eye pillow, blanket, robe, slipper, glove, towel, hair styling supplies, and so forth);
craft supplies (which may include needlepoint supplies, scrapbooking supplies, knitting supplies, sewing supplies, paper, woodworking supplies, fabric, trim, glue, jars, model kit, candles, candle making supplies, paint, crayons, pins, pens, wood, wire, Styrofoam, soaps, ribbon, a nail, a screw, a hinge, a box, canvas, a rubber stamp, a stamp pad, feathers, doilies, silk flowers, dried flowers, a pipe cleaner, potpourri, raffia, a wreath, a basket, lace, felt, a magnet, rope, twine, a glue gun, glue sticks, stickers, mesh, beads, a charm, a frame, rubber bands, string, and so forth);
art supplies (which may include painting supplies, drawing supplies, sculpture compounds, sculpture tools, paper, canvas, woodworking equipment, ceramic supplies, coloring dye, scissors, glue, a camera, a camera flash, a camera lens, photography supplies, photography equipment, modeling clay, modeling figures, and so forth);
party supplies (which may include party favors, novelties, tea lights, cake mix, frosting, candles, streamers, balloons, party games, table covers, invitations, a piñata, a tent, posters, plants, flowers, decorative lighting, banners, confetti, alcoholic beverages, carbonated beverages, drink mixers, snack mix, audio producing device, light producing device, pyrotechnic supplies, and so forth);
   to note but a few. In addition, the post-catastrophe supplies may include replacement parts for the other supplies provided to the authorized beneficiary. For example, if a particular resource requires batteries, ink cartridges, dice, or chips, a quantity of such supplies may be included to provide a back-up for lost, broken, expended, or deteriorated parts.

If an authorized beneficiary requests game accessories, the supplies included may accommodate a number of different games or in combination with other supplies can accommodate different numbers of players or different games. The supplies included in the unit may accommodate games that require batteries, an AC/DC electrical power supply, dice, game pieces, randomness, luck, numbers, letters, symbols, time, currency, talking, bidding, flipping, visual skill, a ball, team units, physical skill, throwing, shooting, hitting, skating, sticking, grappling, strength, moving an object, dexterity, mental skill, intelligence, exchanging information, language skill, talking, exchanging game pieces, and so forth.

The procured supplies may be stored in aggregate such that all of a certain kind of supply is stored together. By another approach, or in combination with an aggregate approach, some or all of the acquired supplies may be stored in subscriber-based bundles or units. This process 100 also provides for creating 105 a unit of post-catastrophe supplies primarily directed toward entertainment and recreation. By one approach, segregating the post-catastrophe supplies is accomplished by segregating or removing the resources for one authorized beneficiary from a larger collective supply or aggregation of resources. For example, segregating can include removing a carton or small box of supplies from a larger bin or larger pallet of aggregated supplies. Further, such segregation of supplies may comprise encapsulating, bundling, or otherwise restraining the removed supplies. By another approach, segregating the post-catastrophe supplies can be accomplished by gathering different supplies possibly procured from different sources and combining those supplies gathered from several different sources. Creating 105 a unit of supplies occurs, for example, when a board game, a video recorder, a video game console, video games, video game accessories, each issue of a certain periodical publication published within the last year, and a set of scuba gear are acquired and then are combined to create the unit of post-catastrophe supplies dedicated to entertainment and recreation. In yet another form, creating 105 the sub-unit may comprise both partitioning off a portion of supplies and combining supplies from different sources. The units may be a useful tool when delivering the survival supplies to the authorized beneficiaries, in response to a civilly-catastrophic event.

Creating 105 the subscriber-based bundle or unit of supplies may make the supplies more readily deliverable to the authorized beneficiary. To create the unit a number of encapsulating or restraining mechanisms may be employed. By one approach, at least some of the units comprise one or more pallets (as are known in the art) that have resources stacked thereon. For example, various tie-downs and/or tarps or other coverings can be employed in such a case to hold the resources in one place on the pallet. Palletization, in turn, will permit ready and efficient movement of such bundles to, about, or from a given storage facility and/or delivery of such a bundle or unit to an authorized beneficiary when such delivery comprises the desired form of granting access to such resources. By another approach, the unit may comprise a closable container made of wood, metal, plastic, canvas, or other materials. The containers may be lockable or structured to interlock with other unit containers of supplies. In addition, the container for the post catastrophe supplies, like the supplies stored therein, may be used for entertainment or recreation purposes. For example, the container, either as is or with some reconfiguration, may be used as playhouse or a slide for children.

In one embodiment, a basic or standard unit of post-catastrophe supplies dedicated to entertainment or recreation is available. This universal unit preferably includes a wide variety of supplies that can provide for a variety of different activities, events, performances, and so forth. The universal unit is preferably a largely unisex, uniage, one-size-fits-all selection of supplies. Utilizing universal units allows for some convenience with respect to managing the resources. The unit enjoys a certain level of fungibility such that the unit received by one beneficiary is nearly identical to that received by another.

In another form, the process 100 also provides for differentiation 107 of the supplies included in the unit. The differentiated unit still is primarily directed to entertainment or recreation purposes, but contain different kinds or types of supplies directed to entertainment and recreation. The difference between the supplies can be quite small or can become quite significant. For example, one unit may be directed to adult craft supplies and art supplies, such that the unit contains photography equipment and supplies, paints, brushes, and canvas suitable for use by an adult. In another unit, the supplies may be directed to adult reading and learning supplies and yet another unit may include picture books, plush toys, and building blocks suitable for use by a child. Thus, differentiation can occur based upon a number of factors. Further, as discussed above, the supplies provider may also offer the standard unit containing supplies directed to a broader audience.

Providing for differentiation of the units allows the post-catastrophe supplies to be tailored to the preferences, requirements, and needs of the authorized beneficiary. Differentiated units also provide a level of customization without having to construct an entire unit by deciding on each detail and starting from scratch. In one preferred form, the differentiated units are predetermined such that the authorized beneficiary can choose between a number of units directed to certain preferences or characteristics.

In one preferred embodiment, it is expected that each there will be a plurality of differentiated units. The units may be differentiated based on a number of factors that might include, but are not limited to:

age;

experience;

interests;

gender;

likelihood of use;

lifestyle;

cost;

personal preference;

location;

brand;

resolution;

packaging;

size;

portability;

weight;

shelf life;

accessibility;

ease of use;

storage requirements;

appearance;

ruggedness;

texture;

color;

odor;

taste;

mouth feel;

touch;

nutritional content;

sound;

compatibility;

climate;

shape;

composition;

efficacy;

durability;

season;

noise;

interoperability;

threat assessment;

additional supplies provided;

health and medical condition of individuals;

type of material;

number of individuals that can utilize the entertainment material;

number of individuals accommodated;

weather requirements;

functionality;

to note but a few. By one approach, for example, differentiation based on age may comprise having a unit directed to youth including toys, games, and clothing sized for a particular age range.

This process 100 also permits authorized beneficiaries and subscribers to customize 109 the post-catastrophe supplies and thus, a plurality of subscription opportunities are available. Additionally (or in lieu of such an approach), the supplies provider or an interested third party may customize the supplies for the authorized beneficiary. As yet another example, the subscriber may seek to customize the resources provided on behalf of a given authorized beneficiary. This plurality of differentiated subscription of opportunities can correspond, for example, to providing access to different categories, quantities, types, or qualities of resources and different bundles or groups of resources. As but one very simple illustration in this regard, such subscription opportunities can differ from one another at least with respect to cost. This, in turn, provides subscriber choice with respect to selecting a particular subscription that best meets their specific needs, preferences, and/or budget limitations. While universal and differentiated units of entertainment or recreation supplies are available, those units are preferably mass produced and the contents are often predetermined. The customized units accommodate an authorized beneficiary who wants to select each aspect of the unit such that the supplies are chosen individually or in an a la carte fashion. By another approach, the customized unit accommodates an authorized beneficiary who requests so many upgrades to the universal or differentiated unit that not a single item typically included in the universal or differentiated unit will be received by the authorized beneficiary. The customized unit, like the differentiated unit, accommodates authorized beneficiaries who want to items to be added to their bundle of supplies. However, unlike the differentiated unit, each supply included in the customized unit is selected by the authorized beneficiary.

Some authorized beneficiaries may chose to customize their resources relative to what other authorized beneficiaries have chosen. The authorized beneficiary may chose a group of people with whom resources may be combined together. For example, an extended family may need only one swing set; therefore, an authorized beneficiary may request a swing set provided no other authorized beneficiary in the group has already requested one. This allows groups of authorized beneficiaries and subscribers to coordinate their efforts to prepare for civilly-catastrophic events. In addition, authorized beneficiaries may request additional items if others have specifically not requested the resource, or not a certain amount of the resource. For example, one authorized beneficiary may request a certain number of batteries and may further request that number be doubled if no other authorized beneficiary in their group request more than a certain number of such batteries. Such customization does require information of the choices of other authorized beneficiaries.

This process 100 also optionally provides for maintaining 111 the units pending a need to provide subscription-based access to the supplies. The specifics of such maintenance will of course vary with respect to the nature of the resource or resources being maintained and the preferences of the authorized beneficiary. As suggested above, the supplies and resources may be stored in subscriber-based bundles or units. Grouping or segregating the supplies in such a manner may impact the maintenance process. Maintaining the supplies may comprise ensuring the utility of the stored supplies. The supplies may need to be updated on a periodic basis to ensure, for example, freshness, usability, and efficacy of the supplies. In one form, this can comprise monitoring the usability of perishable items and replacing such items on a corresponding schedule. As another simple illustration, this can comprise holding certain items in deep refrigeration or in other special storage conditions as may suit the proper maintenance of such items.

Such maintenance can also comprise making adjustments to such supplies to reflect dynamically changing circumstances as occur during the consideration-based private civil security subscription period. Advancements in technology will often produce more efficient and effective resources, such that the previously stored resources will need to be substituted. As one illustration, a new item may become available that is particularly useful in providing power to small electronic devices. In such a case, maintaining the unit of supplies can readily accommodate updating the acquired and stored items to include one of these new items.

Accordingly, such maintenance can readily comprise one or more of removing a particular one of the items (as when a better substitute becomes available, when the item itself is shown to be less effective for its intended purpose than was originally thought, when the authorized beneficiary has chosen to receive another item, and so forth), adding additional ones of the stored supply (as when it becomes subsequently understood that more of a particular item is desired to achieve a particular survival related goal or purpose, or an authorized beneficiary has changed preference), adding at least one new supply that is not already stored (as in the example provided above) and so forth.

It will be appreciated that these teachings provide for a highly flexible yet powerfully effective way by which a modern citizen can greatly improve their likelihood of surviving a civilly-catastrophic event and thriving after such an event. These teachings are sufficiently flexible so as to accommodate the needs and desires of a wide-ranging set of potential beneficiaries while nevertheless still tending to ensure adequate access to basic supplies. Further, the teachings provide a manner to accommodate the individual beneficiary while creating a viable manner to implement such a large-scale provision of post-catastrophe supplies. Though training and some related activity may be provided and encouraged, in general the beneficiary receives those benefits without being required to make the commitment of time, energy, and expertise that would ordinarily be associated with attaining such a high level of security.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method comprising:
accepting pre-catastrophe consideration-based private civil security subscriptions from subscribers with respect to providing civilly-catastrophic event-based access to survival supplies for authorized beneficiaries; and
providing the survival supplies wherein providing the survival supplies comprises, at least in part, creating a unit of post-catastrophe supplies substantially dedicated to entertainment material.

2. The method of claim 1 wherein the entertainment supplies comprise both entertainment and recreation supplies.

3. The method of claim 2 wherein the unit of post-catastrophe supplies comprises at least one of:
media supplies;
a game accessory;
a children's toy;
a wheeled vehicle;
a ball;
a coin;
sports equipment;
reading material;
a musical instrument;
sheet music;
an amplifier;
a microphone;
a mixing console;
instrument connectivity cables;
a karaoke machine;
a remote control car;
racing equipment;
racing accessories;
a jigsaw puzzle;
a puzzle collection;
spa equipment;
spa supplies;
craft supplies;
art supplies;
party supplies.

4. The method of claim 3 wherein the media supplies comprise at least one of:
a media console;
a media display;
a media player;
media content;
media accessories;
a videogame console;
videogames;
videogame accessories;
an audio player;
headphones;
speakers;
a camera;
a video recorder;
an electronic game;
a personal computer;
a hard drive;
a media recorder.

5. The method of claim 3 wherein the game accessory comprises at least one of:
a board game;
playing cards;
card game accessories;
dice;
chips;
jacks;
string;
gambling equipment;
gambling accessories;
videogame equipment;
videogame supplies;
a computer;
computer accessories;
a game controller;
a wireless game controller;
a headset;
a wireless headset;
a power inverter;
a foosball table;
an air hockey table;
a table hockey unit;
a handheld game;
chess supplies;
an arcade game;
a pinball machine;
game instructions;
marbles;
tic-tack-toe set;
pick-up-sticks;
shuffleboard equipment and supplies.

6. The method of claim 3 wherein the children's toy comprises at least one of:
building sets;
models;
blocks;
play sets;
magic tricks,
magic accessories;
dress-up clothing;
a doll;
doll accessories;
a doll house;
doll clothes;
a yo-yo;
a flying disc;
an action figure;
action figure accessories;
plush toys;
stuffed animals;
string;
playground equipment;
a water sprinkler;
a musical instrument;
a train;
train accessories;
a bicycle;
a vehicle;
trucks;
cars;
die-cast figures;
modeling dough;
a balloon;
a scooter;
a tricycle;
a wagon;
stilts;
a squirt gun;
a water gun;
a pogo-stick
a flying triangle;
a flying donut-shaped object.

7. The method of claim 3 wherein the reading material comprises at least one of:
children's books;
children's educational activity books;
a periodical;
a non-periodical;
a magazine;
a newspaper;
a newsweekly;
a scientific journal;
an artistic journal;
an academic journal;
a special interest journal;
a manual;
educational text;
reference material;
an encyclopedia;
a dictionary;
a pamphlet;
a review;
an audio book;
a comic book;
papers;
classical literature;
fictional material;
non-fictional material;
historical material;
memoirs;
dramatic material;
poetry;
prose;
ballad;
classics;
epic literature;
legendary material;
mythical material;
folklore;
erotica;
essay-based material;
science fiction material.

8. The method of claim 7, wherein the reading material comprises at least one of:
a hardback book;
a paperback book;
digital copies;
audio tape;
microfilm;
microfiche;
magazine;
newspaper;
flyer;
pamphlet.

9. The method of claim 3, wherein the sports equipment comprises at least one of:
a bat;
a stick;
a racquet;
a paddle;
a ball;
a net;
a shuttlecock;
a goal structure;
a base;
a mitt;
a glove;
goggles;
a swim cap;
scuba gear;
flotation devices;
batting practice system;
a ball return;
a rope;
a mallet;
a helmet;
protective gear;
sports shoes;
stretching equipment;
a yoga mat;
a road bike;
an off-road bike;
sports clothing;
exercise equipment;
free weights;
a pedometer;
a punching bag;
a jump rope;
a canoe;
a kayak;
a trampoline;
ice skates;
roller skates;
in-line skates;
a skateboard;
a fishing rod;
a fishing reel;
fish hooks;
fish bait;
a fishing net;
a crab trap;
a knife;
a tackle box;
fishing tackle;
paintball equipment;
croquet equipment;
a pogo stick;
stilts;
a bow;
arrow shafts;
arrow heads;
archery accessories;
a target;
firearms;
a handgun;
a muzzleloader;
a shotgun;
a rifle;
an air gun;
a sporting clay gun;
a shooting vest;
hull bags;
shell bags;
clay birds;
binoculars;
shotgun reloading components;
ammunition;
a firearm cleaning kit;
a scope;
scents and decoys;
a tree stand;
animal call devices;
a golf club;
a golf bag;
golf tees;
golf accessories;
darts;
a dart board;
dart accessories;
bean bags;
horse shoes;
stakes;
lawn jarts;
a pool cue;
a billiard table;
a ping pong table;
bowling pins;
scuba gear;
a bungee cord.

10. The method of claim 3 wherein the puzzle collection comprises at least one of:
sudoku puzzles;
cross word puzzles;
word search puzzles;
letter arrangement games;
cryptograms;
block figure puzzle.

11. The method of claim 3 wherein the spa equipment comprises at least one of:
a massage table;
a foot bath;
a manicure station;
a stylist chair;
towels;
hair styling equipment;
a tanning bed;
a whirlpool;
a steam bath;
a steam room;
a sauna;
a mud bath.

12. The method of claim 3 wherein the spa supplies comprise at least one of:
polish;
oil;
scrub;
files;
scissors;
wax;
wraps;
muslin strips;
brushes;
razors;
dye;
pillow;
eye pillow;
blanket;
robe;
slipper;
glove;
towel;
hair styling supplies.

13. The method of claim 3 wherein the craft supplies comprise at least one of:
needlepoint supplies;
scrapbooking supplies;
knitting supplies;
sewing supplies;
paper;
woodworking supplies;
fabric;
trim;
glue;
jars;
model kit;
candles;
candle making supplies;
paint;
crayons;
pins;
pens;
wood;
wire;
Styrofoam;
soaps;
ribbon;
a nail;
a screw;
a hinge;
a box;
canvas;
a rubber stamp;
a stamp pad;
feathers;
doilies;
silk flowers;
dried flowers;
a pipe cleaner;
potpourri;
raffia;
a wreath;
a basket;
lace;
felt;
a magnet;
rope;
twine;
a glue gun;
glue sticks;
stickers;
mesh;
beads;
a charm;
a frame;
rubber band;
string.

14. The method of claim 3 wherein the artistic supplies comprise at least one of:
painting supplies;
drawing supplies;
sculpture compounds;
sculpture tools;
paper;
canvas;
woodworking equipment;
ceramic supplies;
coloring dye;
scissors;
glue;
a camera;
a camera flash;
a camera lens;
photography supplies;
photography equipment;
modeling clay;
modeling figures.

15. The method of claim 3 wherein the party supplies comprise at least one of:
party favors;
novelties;
tea lights;
cake mix;
frosting;
candles;
streamers;
balloons;
party games;
table covers;
invitations;
a piñata;
a tent;
posters;
plants;
flowers;
decorative lighting;
banners;
confetti;
alcoholic beverages;
carbonated beverages;
drink mixers;
snack mix;
audio producing device;
light producing device;
pyrotechnic supplies.

16. The method of claim 3 wherein replacement parts for the post-catastrophe supplies included in the unit.

17. The method of claim 1 wherein creating the unit substantially dedicated to entertainment material further comprises creating differentiated units wherein the differentiated units include different kinds of entertainment supplies.

18. The method of claim 17 wherein the differentiated units are differentiated based at least in part upon at least one of a target:
age;
experience;
interests;
gender;
likelihood of use;
lifestyle;
cost;
personal preference;
location;
brand;
resolution;
packaging;
size;
portability;
weight;
shelf life;
accessibility;
ease of use;
storage requirements;
appearance;
ruggedness;
texture;
color;
odor;
taste;
mouth feel;
touch;
nutritional content;
sound;
compatibility;
climate;
shape;
composition;
efficacy;
durability;
season;
noise;
interoperability;
threat assessment;
additional supplies provided;
health and medical condition of individuals;
type of material;
number of individuals that can utilize the entertainment material;
number of individuals accommodated;
weather requirements;
functionality.

19. The method of claim 1 wherein the unit of post-catastrophe supplies substantially dedicated to entertainment material includes supplies not likely anticipated by the authorized beneficiary to provide an element of surprise.

20. The method of claim 1 further comprising:
maintaining the survival supplies pending a need to permit civilly-catastrophic event-based access to the survival supplies.

21. The method of claim 20 wherein maintaining the survival supplies comprises, at least in part, modifying the survival supplies over time to accommodate changing preferences with respect to entertainment material.

22. The method of claim 21 wherein modifying the survival supplies over time to accommodate changing preferences with respect to entertainment material comprises modifying the survival supplies over time to accommodate changing general preferences with respect to entertainment material.

23. The method of claim 22 wherein modifying the survival supplies over time to accommodate changing preferences with respect to entertainment material comprises modifying the survival supplies over time to accommodate changing specific preferences of particular ones of the authorized beneficiaries with respect to entertainment material.

24. The method of claim 1 wherein accepting pre-catastrophe consideration-based private civil security subscriptions from subscribers with respect to providing civilly-catastrophic event-based access to survival supplies for authorized beneficiaries comprises accessing a higher amount of consideration for a subscription as provides civilly-catastrophic event-based access to survival supplies that include the unit of post-catastrophe supplies substantially dedicated to entertainment material than for a comparable subscription that does not provide civilly-catastrophic event-based access to survival supplies that include the unit of post-catastrophe supplies substantially dedicated to entertainment material.

25. The method of claim 1 wherein creating a unit of post-catastrophe supplies substantially dedicated to entertainment material further comprises using a container for the unit of post-catastrophe supplies substantially dedicated to entertainment material that itself comprises, at least in part, entertainment material.

26. The method of claim 25 wherein the container comprises, at least in part:
an electronic media playback device;
a source of electric power for electrically-powered playback devices;
interlocking play blocks;
a playhouse of sufficient size to accommodate at least one human child;
a toybox;
a slide;
a swing set;
a teeter totter.
